(19) United States
(12) Patent Application Publication
(10) Pub. No.: US 2020/0375142 A1
(43) Pub. Date: Dec. 3, 2020

(54) ASSEMBLY OF A LIVING SURFACE AND A PROCESSING DEVICE FOR PROCESSING URINE

(71) Applicant: LELY PATENT N.V., Maassluis (NL)

(72) Inventors: Karel VAN DEN BERG, Maassluis (NL); Shiva Sadat SHAYEGAN SALEK, Maassluis (NL); Johannes Maria VAN DER KROON, Maassluis (NL); Ernst Arnout ROSCAM ABBING, Maassluis (NL); Roelof STAPEL, Maassluis (NL); Petrus Johannes VAN SCHIE, Maassluis (NL); Maarten VAN DEN BERG, Maassluis (NL)

(73) Assignee: LELY PATENT N.V., Maassluis (NL)

(21) Appl. No.: 16/093,472

(22) PCT Filed: Apr. 4, 2017
(86) PCT No.: PCT/NL2017/050207

§ 371 Date: Oct. 12, 2018

(30) Foreign Application Priority Data
Apr. 15, 2016 (NL) 2016618

(51) Int. Cl. A01K 1/01; A01K 1/015; B01D 1/16; B01D 3/34; C02F 1/20

(52) U.S. Cl. CPC A01K 1/0103; A01K 1/0151; C02F 2103/20; B01D 3/346; C02F 1/20; B01D 1/16

(57) ABSTRACT

In an assembly of a living surface for a farm mammal, in particular cattle, and a processing device for processing urine from the farm mammal, the living surface is configured to catch the excretory products including feces and urine from the farm mammal, wherein the assembly includes a urine removal device for removing urine essentially separately from feces and draining the urine from the living surface in a urine-rich stream, and is configured to feed the urine-rich stream to the processing device, and wherein the processing device includes a nitrogen removal device for removing nitrogenous substances from the urine-rich stream.

The invention relates to an assembly of a living surface and a processing device for processing urine. An assembly of a living surface and a processing device for processing excretory products such as urine and feces is known. Ordinarily, this is a stall for farm mammals comprising a slatted floor under which a collection area for feces and urine, referred to as a manure cellar, is located. The feces and urine fall through the openings in the slatted floor into the collection area in mixed form as so-called liquid manure. An alternative is a solid living surface on which the feces and urine are slid into a cistern by means of a slide. In this embodiment as well, the feces and urine are collected in mixed form. It is known that feces contain the enzyme urease, which converts the urea in urine into ammonia and carbon dioxide. The ammonia formed is certain to evaporate readily into the air in a neutral or basic environment, which is undesirable.

Liquid manure has always been in widespread use as fertilizer. All individual basic fertilizers, such as nitrogenous ammonia, potassium, dissolved and fixed phosphate, and solid and dissolved organic substances, are present in liquid form. However, each season, plant species, soil type, etc. requires a different composition of basic fertilizers for optimum fertilization. It is therefore desirable to separate the excretory products into a plurality of fertilizer streams. This makes more targeted fertilization possible, resulting in less fertilizer loss. In addition, liquid manure often has a negative commercial value, while separated fertilizer streams have a positive one. If certain fertilizers have to be eliminated from the company according to specified legislation, this can be carried out in an economical manner by means of separated streams.

A stall floor with a liquid-permeable upper layer above a layer comprising objects with an open structure is known from EP2260969. Urine located on the upper layer can drip through. The ammonia in the urine is converted to nitrate by bacteria living on the objects with the help of oxygen. The effluent is collected under the floor and can be used to fertilize land. All of the fertilizers originally present in the urine, such as nitrogen and potassium, remain present in the effluent, and are not separated into individual streams.

WO2014051421 discloses a self-navigating vehicle for removing manure from a stall floor. The floor is permeable to urine. Urine passing through the floor is drained, and all fertilizers originally present in the urine remain present in the effluent and are not separated into individual streams.

A gas removal device for removing a volatile gas such as ammonia gas from a liquid, such as (liquid) fertilizer, comprising at least a first and a second rotating disk of porous material, is known from WO2010126361. The first rotating disk is partially in the liquid. By means of the rotation, the absorbed liquid is moved above the liquid level, allowing the volatile gas to enter the gas phase. The gas is then again taken up in the absorbed liquid by means of an adjacent rotating second disk. In turn, this second disk is also partially in a second liquid. Because this second liquid has a low pH, it takes up only the ammonia from the gas phase. As the first liquid contains liquid manure, the first rotating disk will rapidly become encrusted and readily become obstructed.

The object of the invention is to provide a simple and robust device that separates excretory products of farm mammals into different fertilizer streams and overcomes the drawbacks of prior art described above.

This is achieved by the assembly of claim 1. By using urine removal means in order to drain fresh urine from the living surface separately from feces, it becomes possible to work with a liquid in which nitrogenous compounds in the urine such as urea and ammonia are relatively concentrated in solution. This makes it possible for the relatively pure fertilizer stream to be easily further separated in the nitrogen removal device. In this case, it is also helpful that no or few solid components from the feces are present in the urine-rich stream. These can easily cause blockages and disturbances in a nitrogen removal device. In any storage of ammonia dissolved in water, as is the case for urine, ammonia will evaporate. For this reason, a nitrogen removal device is not intended for storage, but is a device that promotes (contains agents to promote) the removal of nitrogen from the urine-rich stream.

According to an advantageous embodiment of the invention, the drainage means comprise a urine-permeable floor with a urine collection container that is effectively connected to the processing device for storing the collected urine-rich stream. This makes a simple construction without moving parts possible. The urine simply collects under the floor due to the force of gravity. As the urine remains in the urine collection container for a certain time, the urease enzyme present has time to convert urea into ammonia and carbon dioxide gas:

(NH₂)2CO+H₂O→2NH₃+CO₂

The urease enzyme is derived from the residual feces unavoidably entrained from the floor to the urine-rich stream.

According to a further advantageous embodiment of the invention, the urine removal means comprises an remover that can be moved over the floor surface for removing the urine essentially separately from the feces and draining the urine in a urine-rich stream into a urine collection container. For such an embodiment, only a simple and inexpensive solid floor is required. Such a system can also easily be used in existing buildings and living spaces, because no or few structural adjustments have to be made. This remover can optionally be combined with a feces collection robot. This makes it possible to collect both the urine and the feces in a single working step.

According to yet another advantageous embodiment of the invention, the urine collection container is connected to an inlet of the nitrogen removal device for accelerated removal of ammonia from the urine-rich stream, said nitrogen removal device comprising a gas outlet for discharging an ammonia-rich gaseous stream and an effluent outlet for discharging a low-nitrogen effluent stream. Because ammonia gas escapes from the liquid and other fertilizers such as potassium and solid components remain behind, this gives a pure N-rich stream. CO₂ and water also escape. Because of the favorable contact of the urine-rich stream with oxygen, urea is also more quickly broken down from the urine into ammonia and carbon dioxide.

In this case, it is particularly advantageous that the urine-rich stream has a high pH, as it is not or only slightly mixed with relatively acidic feces. This high pH causes the ammonia equilibrium:

NH₃+H₂O←→NH₄⁺+OH⁻

to be shifted to the left side. The high concentration of (hydrated) ammonia causes the gaseous ammonia to be separated from the solution. In order to enhance its effect, the nitrogen removal device comprises a heating device for heating the urine-rich stream. A warmer urine-rich stream increases the release of ammonia because the solubility decreases. A warmer solution also accelerates the conversion reaction of urea into ammonia.

It is advantageous if the nitrogen removal device comprises a gas stripper with a packed column. Such a column provides a robust and simple structure without many movable parts.

In particular, the nitrogen removal device comprises a surface stripper with a storage unit for containing the urine-rich stream and comprising at least one evaporation surface that is movable through the storage unit with the urine-rich stream and up to the liquid level of the urine rich stream, a gas outlet for discharging an ammonia-rich gaseous stream, and an effluent outlet for discharging a low-nitrogen liquid stream. The evaporation surface is composed of an absorbent substance or adsorbent material to which a thin layer of urine-rich stream adheres when it is placed in the urine-rich stream. By bringing this surface above the liquid level, the ammonia is caused to evaporate from the adhering liquid layer. Because the ammonia evaporates from the urine-rich stream, the remaining effluent from the urine-rich stream will be low in nitrogen content. Urine tends to rapidly form foam when it is in motion together with air. The advantage of a surface stripper is that the evaporation surface moves through the liquid only slowly, with the result that little turbulence occurs and foam formation is minimal. This slow movement also requires little energy.

Furthermore, it is advantageous if the surface stripper comprises a disk that is rotatable above an almost horizontal axis of rotation, with said disk comprising the evaporation surface. Such a structure has few moving parts and is robust and easy to maintain. This is definitely an advantage in a highly aggressive environment with ammonia evaporation. In an alternative embodiment, the evaporation surface is composed of a rotatable band.

It is advantageous if the surface stripper comprises a plurality of disks that are arranged in series with the corresponding evaporation surfaces transverse to the normal flow direction of the urine-rich stream through the surface stripper. In this embodiment, the successively arranged disks give rise to a sluggish flow effect that provides higher separation efficiency.

In a further particular embodiment, the gas outlet is connected to a gas inlet of an absorber, in particular a packed bed absorber, a liquid inlet for feeding in absorption liquid, a liquid outlet for discharging a nitrogen-rich liquid stream, and an absorber gas outlet for discharging a gaseous low-ammonia stream. An absorber of this type is a robust and relatively simple structure, an important property in an aggressive environment with urine. The absorption liquid preferably has a low pH in order to rapidly absorb the ammonia from the incoming gas stream and retain it. Washing is preferably carried out with sulfuric acid. This provides a nitrogen-rich liquid stream as an end product with extra sulfur. Such a nitrogen/sulfur combination is a good fertilizer. The absorber is preferably operated in counterflow, which provides an efficient process.

In particular, the absorber gas outlet is in open connection with the atmosphere. This allows water and carbon dioxide to escape into the atmosphere, which provides an extra thickening effect and prevents carbon dioxide from accumulating in the system.

Alternatively, the absorber gas outlet is connected to a gas inlet of the nitrogen removal device. This give rise to a circulating gas stream and obviates the need to discharge a gas stream into the air, which can cause environmental damage due to the escape of e.g. ammonia or foul-smelling substances.

In a further particular embodiment, the absorber comprises a plurality of feed lines for supplying various types of acid to the absorber. This makes it possible to obtain a selective composition of absorption liquid that can be used as fertilizer. For example, by feeding in nitric acid, one obtains dissolved ammonium nitrate, a pure nitrogen fertilizer. By feeding in sulfuric acid, one obtains ammonium sulfate, a nitrogen/sulfur fertilizer. The amount of sulfur in the fertilizer can be controlled by controlling the nitric acid/sulfuric acid ratio.

In a further alternative embodiment of the invention, the effluent outlet is directly or indirectly connectable with a floor sprayer for spraying the living surface. As the effluent is low in ammonia content, spraying does not cause any emission of ammonia. By making the living surface moist, extra water can be caused to evaporate, causing water to be eliminated from the entire process in order to make the various fertilizer streams, in particular the potassium-rich effluent stream, more concentrated. Moreover, by feeding of the effluent stream, the urine on the living surface can be rinsed away in diluted form. This reduces ammonia emissions.

In particular, the assembly comprises feces removal means for removing feces from the living surface essentially separately from urine. In such an embodiment, only one simple solid floor is required. By removing the feces separately from the urine, a feces stream having a low pH is obtained. This low pH causes phosphate to be present primarily in soluble form. A second effect of the low pH is that there will be little methane fermentation and thus emission of the greenhouse gas methane. This aids in sustainability of livestock farming, in particular cattle farming. Moreover, these feces will cause minimal emission of ammonia because they contain hardly any urine. The feces removal means can be configured as a self-navigating robot. The feces removal means are preferably combined with the urine removal means in order to allow compact and efficient removal.

In a further particular embodiment of the invention, the processing device further comprises a fiber separator for separating the removed feces into a fiber-rich fraction and a viscous organic fraction. As the feces have a low pH, phosphate will be present therein primarily in soluble form and will thus primarily be separated out with the viscous fraction. The viscous organic fraction is thus rich in phosphate and particularly well-suited for spring fertilizing with the combination of organic matter and phosphate. If the farming company wishes to eliminate phosphate, this can be done in a selective manner by discharging this viscous organic fraction.

In an alternative embodiment of the invention, a solid separator is arranged between the urine collection container and the nitrogen removal device for separating solid materials such as fibers from the urine-rich stream. For example, this solid separator can be configured as a filter or a fiber press. However, solid components from the feces will often be carried along in the urine-rich stream. Further on in the process, these can cause blockages and disturbances. The separated fibers should have a high pH, as a result of which a large amount of phosphate is deposited therein as insoluble orthophosphate. The solid material from this solid separator is therefore a valuable established fertilizer with a high phosphate content that is easy to store.

The invention further relates to a processing device for use in an assembly according to the invention.

The invention will be discussed in further detail below with reference to a drawing, wherein:

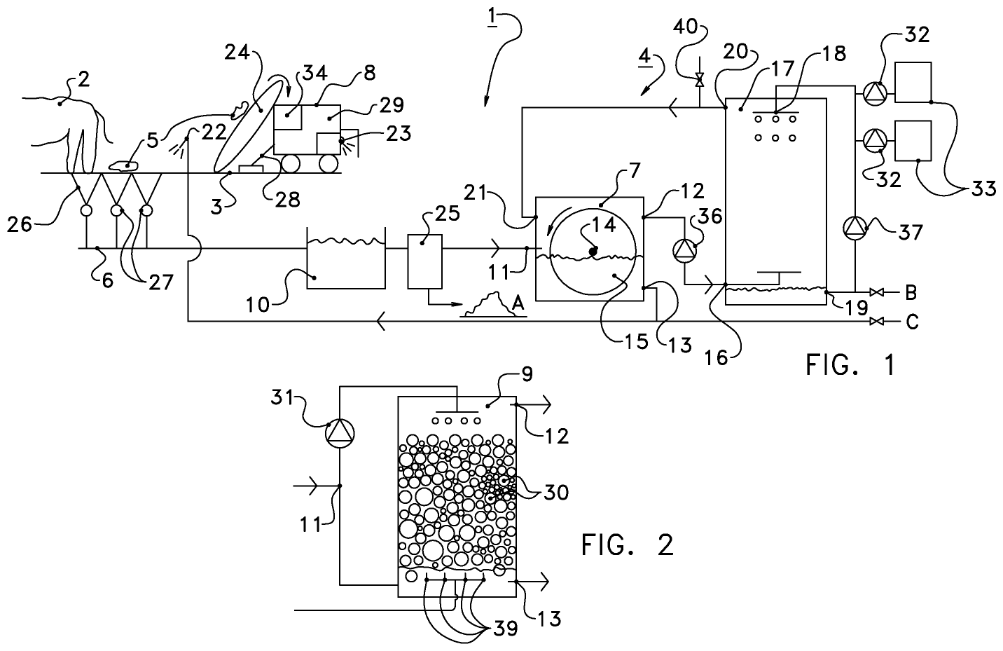

FIG. 1 shows a schematic view of an exemplary embodiment of the system with the various process elements;

FIG. 2 shows a schematic view of an alternative nitrogen removal device according to the invention.

FIG. 1 shows an assembly 1 of a living surface 3 for a farm mammal 2, in particular cattle, and a processing device 4 for processing the urine of the farm mammal 2, wherein the living surface 3 is configured to collect feces excreted by the farm mammal, wherein the assembly comprises urine removal means for removing excreted urine from the living surface 3, essentially separately from feces 5, in a urine-rich stream and configured for supplying the urine-rich stream to the processing device 4, and wherein the processing device 4 comprises a nitrogen removal device 7 for removing nitrogenous substances from the urine-rich stream.

The drainage means comprise a urine-permeable floor 3 with a urine collection container 10 that is effectively connected to the processing device 4 for discharging the collected urine-rich stream. The floor 3 is composed of fabrics of artificial fibers or thread, allowing the urine to seep through immediately after it is excreted by the animal. Under the urine-permeable upper layer, funnel-shaped elements 26 are arranged that collect the urine in gutters 27, which in turn run into a container configured as a urine collection container 10. The urine-rich stream will not be composed exclusively of urine, as it is impossible in practice to prevent it from being contaminated with fecal components.

An remover that is movable over the floor surface 3 also moves on the floor for removing urine essentially separately from the feces 5 and discharging the urine in a urine-rich stream into a urine collection container 10. This remover 8 is configured as a self-navigating robot with a suction device 28 for suctioning up the urine and depositing it in a urine container 29 on the robot. The urine container 29 can be used to dump the urine suctioned up and stored in the urine container 29 at a dumping site in the urine collection container 10. The remover 8 also has a floor sprayer 23 for spraying the living surface 3 with effluent.

The urine collection container 10 is connected to an inlet 11 of the nitrogen removal device 7 for accelerated removal of ammonia from the urine-rich stream, with said nitrogen removal device 7 comprising a gas outlet 12 for discharging an ammonia-rich gaseous stream and an effluent outlet 13 for discharging a low-nitrogen effluent stream.

Between the urine collection container 10 and the nitrogen removal device 7, a solid separator 25 is arranged for separating solid material such as manure fibers from the urine-rich stream. This solid separator is configured as a fiber press. The fibers thus obtained are relatively rich in phosphate and nitrogen and form a separate fertilizer stream A.

The nitrogen removal device 7, 9 is configured as a surface stripper 7 with a storage unit for containing the urine-rich stream and comprising at least one evaporation surface that is movable through the storage unit with the urine-rich stream and up to the liquid level of the urine rich stream 15, a gas outlet 12 for discharging an ammonia-rich gaseous stream, and an effluent outlet 13 for discharging a low-nitrogen liquid stream. The surface stripper 7 comprises a disk 15 that is rotatable about an almost horizontal axis of rotation 14, with said disk 15 comprising the evaporation surface. In order to increase capacity, a plurality of disks 15 is arranged on said axis. Each disk 15 comprises a fabric with a coarse plastic mesh to which the urine-rich stream readily adheres. The disk stripper shown has one row of disks. For efficient operation, the disk stripper can also comprise a plurality of parallel rows. The urine-rich stream then flows in a direction perpendicular to the axes of rotation of the disks along said disks, wherein the air flow above the disks is counter to the flow direction of the urine-rich stream.

FIG. 2 shows an alternative for a surface stripper 7. In this embodiment, the nitrogen removal device 7 comprises a gas stripper 9 with a packed column. A vertical cylinder is filled with fillers 30 known per se in order to increase the contact surface. The urine-rich stream is sprayed on the upper side over the fillers 30. Air is fed in from below through a series of nozzles 39. A circulation pump 31 is configured to pump the urine-rich stream from the bottom back to the top so that it can be again sprayed or atomized via

the nozzle head over the fillers.

The gas outlet 12 of the nitrogen removal device 7 is connected to a gas inlet 20 of an absorber 17 than can be operated in a counterflow, in particular a packed bed absorber similar to that shown in FIG. 2 with a liquid inlet 16 for feeding in absorption liquid, a liquid outlet 19 for discharging a nitrogen-rich liquid stream, and an absorber gas outlet 20 for discharging a gaseous low-ammonia stream. The absorber gas outlet 20 is in turn connected to the gas inlet 21 of the nitrogen removal device 7. The absorption liquid is circulated from the liquid outlet 19 via a circulation pump 37 in a circulation line.

The absorber 17 comprises a plurality of feed lines for the feeding of various types of acid to the absorber. For this purpose, two acid storage units 33 are configured, one with sulfuric acid and one with nitric acid and each having a dosing pump 32, with said pumps being controllable independently of one another. By automatically or manually operating a dosing pump, an acid is optionally pumped into the circulation line in order to keep the pH of the absorption liquid low. The absorption liquid can be tapped as nitrogen-rich fertilizer stream B.

The effluent outlet 13 of the nitrogen removal device 7 is directly connected to a floor sprayer 22 for spraying the living surface 3. For this purpose, floor sprayers 22 are placed at various sites around the living surface 3 that are directly connected to the effluent outlet 13 by a line. The effluent outlet 13 is indirectly connected to a floor sprayer 23 on the robot 8 for spraying the living surface 3. For this purpose, the robot 8 has a spray container that is filled to a filling point with effluent. While in motion, the robot 8 sprays a thin layer of the effluent over the living surface 3 via a nozzle of the floor sprayer 23.

The absorber gas outlet 20 is in open connection with the atmosphere via the open sites of a spray valve 40.

The assembly comprises feces removal means 24 for the removal of feces 5 from the living surface 3 essentially separately from urine. For this purpose, a collection belt 24 is configured entirely on the front side of the robot 8 that picks up feces 5 from the living surface 3 and supplies them to a feces container 34 on the robot 8, with said feces container 34 being configured separately from the urine container 29. This robot 8 supplies the feces 5 to a fiber press, which is not shown and is known per se, for separating the removed feces 5 into a fiber-rich fraction and a viscous organic fraction. The fiber-rich fraction thereof is used as bedding material, for example for farm animals. The viscous organic fraction is fermented in a fermenter, which is not shown, in order to obtain biogas, or can be used as phosphate-rich organic fertilizer.

The assembly works as follows. Excreted urine from the farm mammal 2 falls onto the living surface 3 and then seeps through openings under the living surface 3. Here, it is collected by the funnel-shaped elements 26 and a system of sloping gutters 27 as a urine-rich stream in a urine collection container 10. In addition, a robot 8 moves over the living surface and, and with the collection belt 24, picks up feces 5 lying on the floor surface 3 and deposits them in the feces container 34. A fiber press is fed with the feces 5 from the feces container 34 and separates the feces 5 into a viscous organic fraction and a fiber fraction.

Immediately following the collection belt 24, the suction device 28 suctions up urine lying on the floor surface 3 into the urine container 29, which is under a vacuum. After a notification that the urine container 29 is full, the urine is dumped as a urine-rich stream at a dumping site in the urine collection container 10. From the urine collection container 10, the urine-rich stream is pumped into a fiber press in which fibers from entrained fecal fractions are separated. After this, the purified urine-rich stream flows into the disk stripper 7. A thin liquid layer remains adhering to the disk 15 of the disk stripper 7, which is brought above the liquid level by rotation, after which the ammonia readily evaporates from the liquid layer. Here, the disk 15 acts as a stimulation device. The air mixed with ammonia from the disk stripper 7 is pumped through a blower 36 to the gas inlet 16 of the absorber 17. The remaining liquid at the bottom of the disk stripper 7 can be tapped a s potassium-rich fertilizer stream C.

In the absorber 17, an acidic absorption liquid is continuously circulated via a circulation pump 37. This liquid is sprayed in at the top of the absorber 17 and collected at the bottom and returned to the circulation line 38. While being transported downward, the drops of absorption liquid absorb the ammonia from the air fed in from the disk stripper 7. When the absorption liquid reaches a sufficient concentration of ammonium fertilizer, it can be tapped as a nitrogen-rich fertilizer stream B. After removal, new absorption liquid is fed in via a replenishment line, which is not shown, and adjusted to the proper pH by means of one or both dosing pumps 32. The purified air is fed in at the top of the absorber 17 via the absorber gas outlet 20 and returned to the disk stripper 7.

The entire system finally provides a plurality of product streams derived from the feces 5 and urine: a phosphate-rich viscous organic stream, a solid, relatively phosphate-poor fiber stream, a phosphate-rich fiber stream (A), a liquid nitrogen stream in the form of a solution of ammonium sulfate or ammonium nitrate (B), and a liquid potassium-rich effluent stream (C).

The term ammonia is not to be read as limitative, but can also refer to the ammonia form (NH₄⁺) if the ammonia is dissolved in water.

The absorber 17 shown is a so-called spray tower, which is operated in a counterflow without packing. Any other type is also possible, such as Venturi water, jet water, a plate column, or a packed column. It is also possible to configure the absorber 17 as a disk scrubber. This operates in a manner opposite to the above-described disk stripper 7, i.e. the ammonia is now absorbed from the gas phase on the thin layer of absorption liquid on the rotating disks. By rotation, the thin layer of ammonia is brought below the liquid level, and the thin layer is refreshed with new absorption liquid.

1. An assembly of a living surface for a farm mammal and a processing device for processing urine from the farm mammal, wherein the living surface is configured to catch feces from the farm mammal,
wherein the assembly comprises a urine removal device configured to remove the excreted urine in a urine-rich stream from the living surface essentially separately from the feces, the urine removal device being configured for supplying the urine-rich stream to the processing device, and
wherein the processing device comprises a nitrogen removal device for removing nitrogenous substances from the urine-rich stream.

2. The assembly according to claim 1, wherein the urine removal device comprises a urine-permeable floor with a urine collection container that is effectively connected to the processing device for discharging the collected urine-rich stream.

3. The assembly according to claim 1, wherein the urine removal device comprises a remover that is movable over the floor surface for removing urine essentially separately from the feces and discharging the urine in a urine-rich stream into a urine collection container.

4. The assembly according to claim 2, wherein the urine collection container is connected to an inlet of the nitrogen removal device for accelerated removal of ammonia from the urine-rich stream, with said nitrogen removal device comprising a gas outlet for discharging an ammonia-rich gaseous stream and an effluent outlet for discharging a low-nitrogen liquid effluent.

5. The assembly according to claim 4, wherein the nitrogen removal device comprises a gas stripper with a packed column.

6. The assembly according to claim 4, wherein the nitrogen removal device comprises a surface stripper with a storage unit for containing the urine-rich stream and comprising at least one evaporation surface that is movable through the storage unit with the urine-rich stream and up to the liquid level of the urine rich stream, a gas outlet for discharging an ammonia-rich gaseous stream, and an effluent outlet for discharging a low-nitrogen liquid stream.

7. The assembly according to claim 6, wherein the surface stripper comprises a disk that is rotatable about an almost horizontal axis of rotation, wherein said disk comprises the evaporation surface.

8. The assembly according to, claim 7, wherein the surface stripper comprises a plurality of disks that are arranged in series with the evaporation surface transverse to the normal flow direction of the urine-rich stream through the surface stripper.

9. The assembly according to claim 4, wherein the gas outlet is effectively connected to a gas inlet of an absorber with a liquid inlet for feeding in of absorption liquid, a liquid outlet for discharging a nitrogen-rich liquid stream, and an absorber gas outlet for discharging a gaseous low-ammonia stream.

10. The assembly according to claim 9, wherein the absorber gas outlet is in open connection with the atmosphere.

11. The assembly according to claim 9, wherein the absorber gas outlet is connected to a gas inlet of the nitrogen removal device.

12. The assembly according to claim 9, wherein the absorber comprises a plurality of feed lines for feeding various types of acid to the absorber.

13. The assembly according to claim 4, wherein the effluent outlet is directly or indirectly connectable to a floor sprayer for spraying the living surface with effluent.

14. The assembly according to claim 1, wherein the assembly comprises a feces removal device configured to remove feces from the living surface essentially separately from urine.

15. The assembly according to claim 14, wherein the processing device further comprises a fiber separator for separating the removed feces into a fiber-rich fraction and a viscous organic fraction.

16. The assembly according to claim 4, wherein the processing device comprises a solid separator configured between the urine collection container and the ammonia removal device for separating solid material from the urine-rich stream.

17. A processing device for use in the assembly according to claim 1.

18. The assembly according to claim 3, wherein the urine collection container is connected to an inlet of the nitrogen removal device for accelerated removal of ammonia from the urine-rich stream, with said nitrogen removal device comprising a gas outlet for discharging an ammonia-rich gaseous stream and an effluent outlet for discharging a low-nitrogen liquid effluent.

19. The assembly according to claim 9, wherein the absorber is a packed bed absorber.

20. The assembly according to claim 5, wherein the gas outlet is effectively connected to a gas inlet of an absorber with a liquid inlet for feeding in of absorption liquid, a liquid outlet for discharging a nitrogen-rich liquid stream, and an absorber gas outlet for discharging a gaseous low-ammonia stream.
